(19) United States
(12) Patent Application Publication
(10) Pub. No.: US 2011/0078939 A1
(43) Pub. Date: Apr. 7, 2011

(54) ASSEMBLED TYPE MOUSETRAP DEVICE

(76) Inventor: Chen-Feng Liao, Banqiao City (TW)

(21) Appl. No.: 12/574,913

(22) Filed: Oct. 7, 2009

(51) Int. Cl. A01M 23/20

(52) U.S. Cl. 43/61

(57) ABSTRACT

The present invention relates to a kind of assembled type mousetrap device, which comprises: a boxlike body having one front opening and one rear opening respectively; a trapdoor having one elastic mechanism and one primary assembly component, wherein, the elastic mechanism can urge the trapdoor to automatically resume its closed position after opening, and the trapdoor may be combined with the front opening of the boxlike body via the primary assembly component with the assembly means; moreover, there is one interlocking mechanism connected to the trapdoor that can be used to restrain the trapdoor from its closing position and thereby sustaining its opening status thereof, and additionally, the restraining function of the interlocking mechanism with regard to the trapdoor can be released by the external force; a back cover having one secondary assembly component, in which, the back cover may be combined with the rear opening of the boxlike body via the secondary assembly component with the assembly means; hereinto, while completing the assembly procedure and combining the boxlike body with the trapdoor and the back cover, it will urge the interlocking mechanism to be effectively moved into the boxlike body and hence constructing a mousetrap device collectively; while using this mousetrap device, it will utilize the interlocking mechanism to restrain the trapdoor and also urge the trapdoor to sustain its opening status; when a mouse is entering into the boxlike body through the trapdoor, it will trigger the interlocking mechanism and urge it to remove its restraining force against the trapdoor, thereat, the trapdoor will automatically resume its closed position by means of the elastic force driven by the elastic mechanism and thus capture the mouse within the enclosed boxlike body successfully.

### BACKGROUND OF THE INVENTION

1. Field of the Invention

The present invention relates to a kind of assembled type mousetrap device, and is particularly directed toward an assembled type mousetrap device with an easy packaging structure, which not only can effectively capture the mouse but also be able to prevent such mouse from escaping accordingly.

2. The Prior Art

The known mouse catching device mainly comprises the mouse trap clip, sticky board and mouse trap cage etc. Among them, the mouse trap clip must be put on the floor and tends to harm the kids or pets at home accidently while stepping on it by mistake. Likely, the sticky board also needs to be put on the floor, so it could be stepped on mistakenly by someone in addition to the problem of easy escape. The common mouse trap cage has many holes and pores, therefore, the captured mouse's droppings may possibly overflow out of the cage through those holes or pores and result in serious problems with regard to the family's sanitation and health etc. Furthermore, most of mouse trap cages are bulky, which not only would raise the packing cost, but also would increase the costs of transportation and warehousing. On the other hand, the use of a mouse trap cage was a troublesome problem, because it still needs to kill the mouse in water or wait the mouse to die naturally long enough due to starving after catching it, under this circumstance, it would cause the user a lot of trouble in dealing with the body of dead mouse along with a very nauseous feeling. In addition, supposed that a mouse was caught by a known mousetrap device, it would generate an unprepossessing smell under the frightened and struggling condition, which would sustain for a long time and prevent it from effectively catching other mice again.

The defects of known technique are summarized as follows:

1. The known mouse trap clip tended to harm the kids or pets at home by mistake;

2. The known sticky board could be stepped on mistakenly by someone in addition to the problem of easy escape;

3. Most of known mouse trap cages are bulky, which not only would raise the packing cost, but also would increase the costs of transportation and warehousing;

4. The known mouse trap cage has many holes and pores, therefore, the captured mouse's droppings may possibly overflow out of the cage through those holes or pores and result in serious problems with regard to the family's sanitation and health etc;

5. Supposed that a mouse was caught by a known mousetrap device, it would generate an unprepossessing smell under the frightened and struggling condition, which would sustain for a long time and prevent it from effectively catching other mice again.

Thus, how to improve the above defects of known mousetrap devices, reduce the packing volume of the mousetrap device, and meanwhile providing a mousetrap device which is characterized by more convenience, safety and health etc. has become the most concerned issues of the present invention.

### SUMMARY OF THE INVENTION

The objective of this invention lies in providing an innovative and improved assembled type mousetrap device, which adopts a folding boxlike body having an assembled type structure consisting of the trapdoor, back cover and interlocking mechanism, in such a way that a user can easily and quickly install the interlocking mechanism into a boxlike body, and accomplishing the assembly procedure for the mousetrap device by combining the trapdoor and back cover with the opening positioned at each end of the boxlike body respectively, and meanwhile the distributors of this product also can save their costs of packaging, transportation and storage by means of the foldable boxlike body and knockdown structural components; In addition, while catching a mouse successfully, the user just needs to lift up the mousetrap device from the handhold component that connects both the cover-like body and trapdoor and throwing it away through a convenient, safe and sanitary method.

To achieve the above objectives, the present invention, therefore, provides a kind of assembled type mousetrap device, which comprises:

A boxlike body having one front opening and one rear opening respectively; a trapdoor having one elastic mechanism and one primary assembly component, wherein, the elastic mechanism can urge the trapdoor to automatically resume its closed position after opening, and the trapdoor may be combined with the front opening of the boxlike body via the primary assembly component with the assembly means; a interlocking mechanism connected to the trapdoor that can be used to restrain the trapdoor from its closing position and thereby sustaining its opening status thereof, and additionally, the restraining function of the interlocking mechanism with regard to the trapdoor can be released by the external force; a back cover having one secondary assembly component, in which, the back cover may be combined with the rear opening of the boxlike body via the secondary assembly component with the assembly means; and wherein, while completing the assembly procedure and combining the boxlike body with the trapdoor and the back cover, it will urge the interlocking mechanism to be effectively moved into the boxlike body and hence constructing a mousetrap device collectively; while using this mousetrap device, it will utilize the interlocking mechanism to restrain the trapdoor and also urge the trapdoor to sustain its opening status; when a mouse is entering into the boxlike body through the trapdoor, it will trigger the interlocking mechanism and urge it to remove its restraining force against the trapdoor, thereat, the trapdoor will automatically resume its closed position by means of the elastic force driven by the elastic mechanism and thus capture the mouse within the enclosed boxlike body successfully.

An assembled type mousetrap device as defined in preceding paragraphs, wherein the boxlike body is foldable and is able to minimize its volume through the folding means.

An assembled type mousetrap device as defined in preceding paragraphs, wherein the primary assembly component of the trapdoor consists of a plurality of snaps, thereat the front opening of the boxlike body has formed a plurality of corresponding grooves or orifices, and the trapdoor is able to combine with the boxlike body by engaging the plurality of snaps into the plurality of grooves or orifices.

An assembled type mousetrap device as defined in preceding paragraphs, wherein the secondary assembly component of the back cover consists of a plurality of snaps, thereat the rear opening of the boxlike body has formed a plurality of corresponding grooves or orifices, and the back cover is able to combine with the boxlike body by engaging the plurality of snaps into the plurality of grooves or orifices.

An assembled type mousetrap device as defined in preceding paragraphs, wherein the interlocking mechanism consists of a linkage connecting with a pedal, thereat the linkage is engaged into a position in-between the trapdoor and the pedal, and moreover, the interlocking mechanism is able to restrain the trapdoor from its closing position via the linkage, and by the time while a mouse is stepping on the pedal, the pedal will activate the linkage and force it to move in order to remove the restraining force of the linkage against the trapdoor accordingly.

An assembled type mousetrap device as defined in preceding paragraphs, wherein the bottom end of the trapdoor has formed a slot, thereat, when the trapdoor is being opened, it would force the linkage to engage into the slot so as to restrain the trapdoor from its closing position, moreover, while a mouse is stepping on the pedal, the pedal will activate the linkage and depressing it downwards with a restraining force, so that the linkage will be driven out of the slot and hence urging the trapdoor to resume its closed position automatically.

An assembled type mousetrap device as defined in preceding paragraphs, wherein the trapdoor is a gate, which can be closed from top to bottom while responding to a trapping mouse.

An assembled type mousetrap device as defined in preceding paragraphs, wherein it would further comprise a cover-like body, so that the cover-like body would be able to combine with the trapdoor and hence enclose the trapdoor after combining

An assembled type mousetrap device as defined in preceding paragraphs, wherein the cover-like body has a handhold component to facilitate a user to lift up the mousetrap device with her (or his) hand.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is an exploded view showing relevant components of an assembled type mousetrap device in accordance with one preferred embodiment of the present invention;

FIG. 2 is a schematic view showing the foldable function of boxlike body of an assembled type mousetrap device in accordance with one preferred embodiment of the present invention;

FIG. 3 is a schematic view showing the completely assembled mousetrap device of the preferred embodiment in accordance with the present invention;

FIG. 4 is a schematic view showing the mouse was captured within the enclosed boxlike body of an assembled type mousetrap device in accordance with one preferred embodiment of the present invention; and

FIG. 5 is another schematic view of an assembled type mousetrap device in accordance with one preferred embodiment of the present invention.

### DETAILED DESCRIPTION OF THE PREFERRED EMBODIMENT

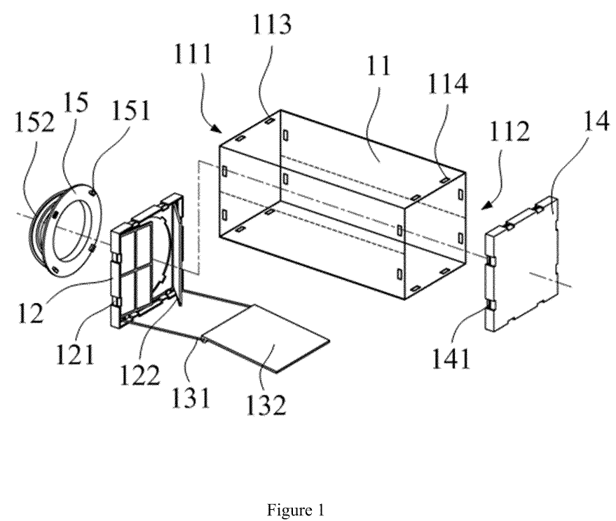

FIG. 1 is an exploded view showing relevant components of an assembled type mousetrap device in accordance with one preferred embodiment of the present invention, where, it comprises a boxlike body 11, front opening 111, rear opening 112, orifices 113, 114, trapdoor 12, snaps 121, 141, 151, groove 122, linkage 131, pedal 132, back cover 14, cover-like body 15 and handhold component 152. The assembled type mousetrap devices pursuant to the present invention primarily consists of a boxlike body 11, trapdoor 12, interlocking mechanism and back cover 14. In which, the boxlike body 11 can be a square shape or in other shapes, and there is one front opening 111 and one rear opening 112 positioned at each end of the boxlike body 11 respectively, thereat, the front opening 111 and rear opening 112 has constructed a plurality of orifices 113 and 114 respectively. On the trapdoor 12 and back cover 14, a plurality of snaps 121, 141 corresponding to orifices 113, 114 are installed at the openings of the boxlike body 11, which are able to combine with orifices 113, 114, and with the combination of snaps 121, 141 and orifices 113, 114, so that the trapdoor 12 and back cover 14 will be able to connect with each end of the boxlike body 11 respectively and hence enclose the front opening 111 and rear opening 112 of the boxlike body 11 accordingly.

The trapdoor 12 has one elastic mechanism, which can be a spring; its elasticity can restrain the trapdoor 12 from sustaining its closed position, or automatically resuming its closed status after opening. Interlocking mechanism can consist of the linkage 131 and pedal 132, while assembling, the interlocking mechanism is engaged into the boxlike body 11, and a linkage 131 is engaged into a position in-between the trapdoor 12 and pedal 132. Groove 122 is formed at the bottom end of the trapdoor 12, thereat, while the trapdoor 12 is being opened, it will urge the linkage 131 to be engaged into the bottom groove 122 of the trapdoor 12 and fastening the linkage 131 at the bottom of the trapdoor 122 to restrain the trapdoor 12 from closing and hence sustaining its opening position. In which, the groove 122 at the bottom end of the trapdoor 12 is positioned toward inclinedly in a way that one end of linkage 131 adjacent to the pedal 132 which is engaged into the groove 122 will raise slightly upwards in order to urge the connection area of pedal 132 and linkage 131 to be raised. In this way while a mouse is entering into the trapdoor 12 and stepping on the raised pedal 132, the depressing force of the pedal 132 will force the linkage 131 to move downwards and pushing the linkage 131 to run out of the groove 122 at the bottom end of the trapdoor 12. Once the linkage 131 has run out of the groove 122 of the trapdoor 12, the linkage 131 will release its restraining force against the trapdoor 12 and under this circumstance; the trapdoor 12 will resume its closed status and hence capture the mouse within the boxlike body 11 successfully.

After catching a mouse, it is available to use a cover-like body 15 to seal the trapdoor 12, wherein, there is a plurality of snaps 151 installed at one side of the cover-like body 15, and there are corresponding orifices formed at the surface of the trapdoor 12, so that the cover-like body 15 can engage into orifices formed at the surface of the trapdoor 12 via snaps 151 so as to enclose the trapdoor 12 consequently. There is one handhold component 152 installed at the cover-like body 15 which will facilitate an user to lift up and throw away the mousetrap device conveniently.

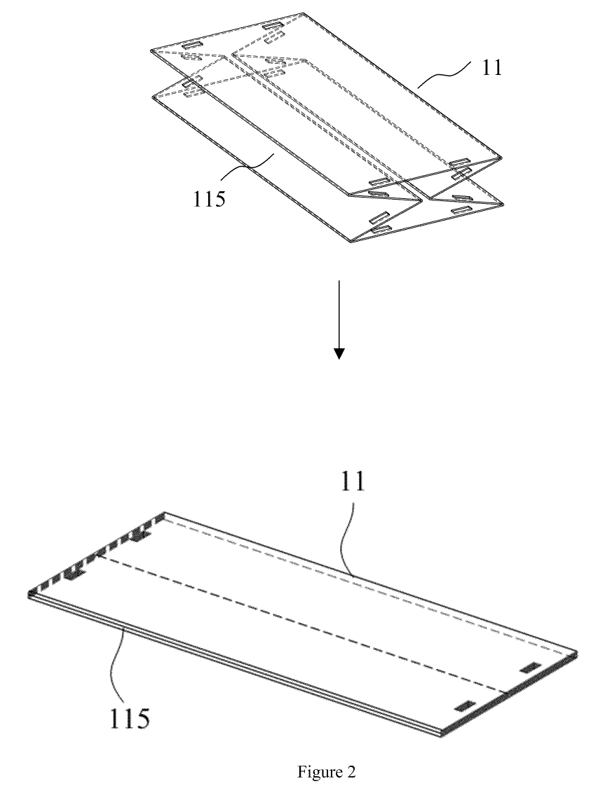

With reference to FIG. 2, it is a schematic view showing the foldable function of boxlike body of an assembled type mousetrap device in accordance with one preferred embodiment of the present invention, which comprises the boxlike body 11 and side board 115. Wherein, the boxlike body 11 can adopt a square structure, which has top plate, bottom plate and two side boards 115. The side board 115 can adopt a foldable material or a design of foldable type structure, so that the boxlike body 11 will be compressed into a flat structure for the purpose of smaller size, easier transportation and storage by means of two side boards 115.

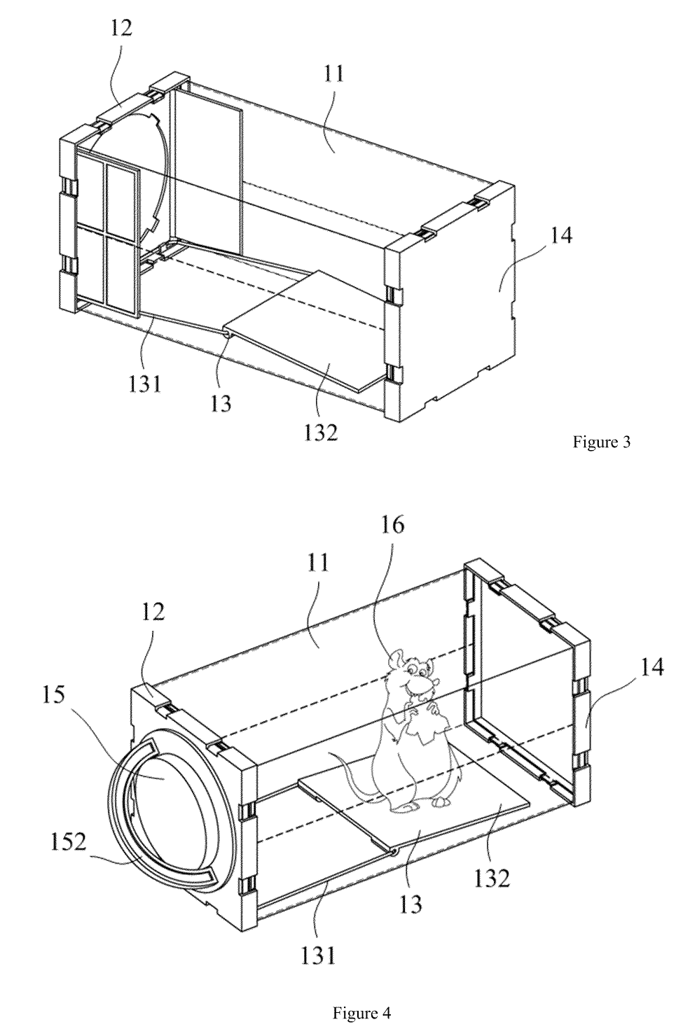

FIG. 3 is a schematic view showing the completely assembled mousetrap device of the preferred embodiment in accordance with the present invention, which comprises the boxlike body 11, trapdoor 12, interlocking mechanism 13, linkage 131, pedal 132 and back cover 14. While completing the assembly procedure, the food used to induce the mouse can be put at a location nearby the back cover 14 within the boxlike body 11, or being put on the pedal 132, and in this way while linkage 131 is engaging into the groove at the bottom end of the trapdoor 12, it will restrain the trapdoor 12 from sustaining its opening position in order to induce the mouse to enter into the boxlike body 11 through the trapdoor 12.

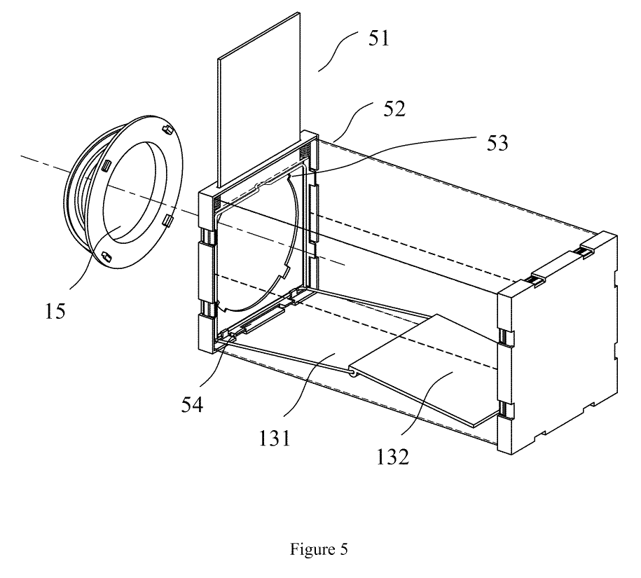

FIG. 4 is a schematic view showing the mouse was captured within the enclosed boxlike body of an assembled type mousetrap device in accordance with one preferred embodiment of the present invention, which comprises the boxlike body 11, trapdoor 12, interlocking mechanism 13, linkage 131, pedal 132, back cover 14, cover-like body 15, handhold component 152 and the mouse 16. When a mouse 16 is entering into the boxlike body 11 to trigger the linkage 131 or the pedal 132, it will urge the trapdoor 12 to close immediately and enclose such mouse 16 within the boxlike body 11. The user can easily lift up the mousetrap device from the handhold component 152 positioned at the cover-like body 15 after enclosing the trapdoor 12 and throw it away at once.

FIG. 5 is another schematic view of an assembled type mousetrap device in accordance with one preferred embodiment of the present invention, which comprises the components such as the gate 51, spring 52, bump 53 and pivot 54 etc. The design of the door plate used for the assembled type mousetrap device pursuant to the present invention can be changed to a gate type. While the gate 51 is being opened, the center portion of bottom edge will be obstructed by the bump 53, and by the time while a mouse is stepping on the pedal 132, it will trigger the linkage to push the bump 53 to move out of the gate 51, so that the gate 51 will close rapidly downwards by means of the elastic force of the spring 52 in order to capture the mouse. Similarly, The user can easily lift up the mousetrap device from the handhold component 152 positioned at the cover-like body 15 after enclosing the trapdoor 12 and throw it away at once.

The advantages of the present invention comprise as follows:
1. The assembled type mousetrap device as defined in accordance with the present invention adopts a foldable boxlike body along with an assembled type structure, which can greatly reduce the overall volume and effectively save the costs of packing, transportation and warehousing;
2. The assembled type mousetrap device as defined in accordance with the present invention is harmless, so it will not accidently harm the kids or pets at home by mistake;
3. The assembled type mousetrap device as defined in accordance with the present invention can rapidly seal the trapdoor or the gate once a mouse is entering into the boxlike body, and it is able to prevent the trapped mouse within the mousetrap device from escaping;
4. The assembled type mousetrap device as defined in accordance with the present invention do not have any hole or pore on its boxlike body, so it will not any problem with regard to the overflowing droppings of trapped mouse; and
5. The assembled type mousetrap device as defined in accordance with the present invention has a simple structure and very low production cost, so the user can throw away this mousetrap device directly after catching a mouse to keep away the serious problems with regard to the family's sanitation and health etc. while dealing with the body of dead mouse

From the foregoing description, the assembled type mousetrap device as defined in accordance with the present invention not only can reduce the costs of packing, transportation and storage, but also has the characteristics of safety, clean, health and convenience etc., which can be deemed to be an innovative and improved application, supposed that any alternative designs, such as changing different kinds of materials, adopting a boxlike body in varied shapes or making the foldable function in different method etc., all can be deemed without departing from the scope of the present invention which is intended to be defined by the appended claims, as long as it is utilizing an assembled method to combine the trapdoor with the back cover and the boxlike body and meanwhile using an interlocking mechanism to control the opening/closing function of the trapdoor.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. An assembled type mousetrap device, which comprises:
a boxlike body having one front opening and one rear opening respectively;
a trapdoor having one elastic mechanism and one primary assembly component, wherein, said elastic mechanism can urge said trapdoor to automatically resume its closed position after opening, and said trapdoor may be combined with said front opening of said boxlike body via said primary assembly component with said assembly means;
an interlocking mechanism connected to said trapdoor that can be used to restrain said trapdoor from its closing position and thereby sustaining its opening status thereof, and additionally, said restraining function of said interlocking mechanism with regard to said trapdoor can be released by said external force; and
a back cover having one secondary assembly component, in which, said back cover may be combined with said rear opening of said boxlike body via said secondary assembly component with said assembly means;
hereinto, while completing said assembly procedure and combining said boxlike body with said trapdoor and said back cover, it will urge said interlocking mechanism to be effectively moved into said boxlike body and hence constructing a mousetrap device collectively; while using this mousetrap device, it will utilize said interlocking mechanism to restrain said trapdoor and also urge said trapdoor to sustain its opening status; when a mouse is entering into said boxlike body through said trapdoor, it will trigger said interlocking mechanism and urge it to remove its restraining force against said trapdoor, thereat, said trapdoor will automatically resume its closed position by means of said elastic force driven by said elastic mechanism and thus capture said mouse within said enclosed boxlike body successfully.

2. An assembled type mousetrap device as defined in claim 1, wherein said boxlike body is foldable and is able to minimize its volume through said folding means.

3. An assembled type mousetrap device as defined in claim 1, wherein said primary assembly component of said trapdoor consists of a plurality of snaps, thereat said front opening of said boxlike body has formed a plurality of corresponding grooves or orifices, and said trapdoor is able to combine with said boxlike body by engaging said plurality of snaps into said plurality of grooves or orifices.

4. An assembled type mousetrap device as defined in claim 1, wherein said secondary assembly component of said back cover consists of a plurality of snaps, thereat said rear opening of said boxlike body has formed a plurality of corresponding grooves or orifices, and said back cover is able to combine with said boxlike body by engaging said plurality of snaps into said plurality of grooves or orifices.

5. An assembled type mousetrap device as defined in claim 1, wherein said interlocking mechanism consists of a linkage connecting with a pedal, thereat said linkage is engaged into a position in-between said trapdoor and said pedal, and moreover, said interlocking mechanism is able to restrain said trapdoor from its closing position via said linkage, and by said time while a mouse is stepping on said pedal, said pedal will activate said linkage and force it to move in order to remove said restraining force of said linkage against said trapdoor accordingly.

6. An assembled type mousetrap device as defined in claim 5, wherein said bottom end of said trapdoor has formed a slot, thereat, when said trapdoor is being opened, it would force said linkage to engage into said slot so as to restrain said trapdoor from its closing position, moreover, while a mouse is stepping on said pedal, said pedal will activate said linkage and depressing it downwards with a restraining force, so that said linkage will be driven out of said slot and hence urging said trapdoor to resume its closed position automatically.

7. An assembled type mousetrap device as defined in claim 1, wherein said trapdoor is a gate, which can be closed from top to bottom while responding to a trapping mouse.

8. An assembled type mousetrap device as defined in claim 1, wherein it would further comprise a cover-like body, so that said cover-like body would be able to combine with said trapdoor and hence enclose said trapdoor after combining.

9. An assembled type mousetrap device as defined in claim 8, wherein said cover-like body has a handhold component to facilitate a user to lift up said mousetrap device with her (or his) hand.
